(19) United States
(12) Patent Application Publication
(10) Pub. No.: US 2024/0407459 A1
(43) Pub. Date: Dec. 12, 2024

(54) AEROSOL GENERATING DEVICE

(71) Applicant: KT&G CORPORATION, Daejeon (KR)

(72) Inventors: Sangkyu PARK, Seoul (KR); Jongsub LEE, Sungnam-si, Gyeonggi-do (KR); Wooseok CHUNG, Namyangju-si, Gyeonggi-do (KR); Byungsung CHO, Gwangmyung-si, Gyeonggi-do (KR); Daenam HAN, Seoul (KR)

(73) Assignee: KT&G CORPORATION, Daejeon (KR)

(21) Appl. No.: 18/698,286

(22) PCT Filed: Oct. 18, 2022
(86) PCT No.: PCT/KR2022/015839

§ 371 Date: Apr. 3, 2024

(30) Foreign Application Priority Data
Oct. 19, 2021 (KR) 10-2021-0139802
Feb. 21, 2022 (KR) 10-2022-0022210

(51) Int. Cl. A24F 40/53; A24F 40/10; A24F 40/30; A24F 40/42; A24F 40/44; A24F 40/46; A24F 40/51

(52) U.S. Cl. CPC A24F 40/53; A24F 40/10; A24F 40/30; A24F 40/44; A24F 40/46; A24F 40/51; A24F 40/42

(57) ABSTRACT

An aerosol generating device is provided. The aerosol generating device according to the present disclosure comprises: a container having a lateral wall that is elongated and shaped to define a storage space that contains a liquid; a plurality of sensors sequentially arranged outside of the lateral wall in a longitudinal direction of the lateral wall, wherein each of the plurality of sensors is configured to detect a volume of the liquid contained in the storage space; a shielding member disposed between adjacent two sensors from among the plurality of sensors; a wick partially positioned inside of the container; and a heater disposed around at least a portion of the wick and being configured to heat the wick.

### TECHNICAL FIELD

The following description relates to an aerosol generating device.

### BACKGROUND ART

An aerosol generating device is a device that extracts certain components from a medium or a substance by producing an aerosol. The medium may contain a multicomponent substance. The substance contained in the medium may be a multicomponent flavoring substance. For example, the substance contained in the medium may include a nicotine component, an herbal component, and/or a coffee component, and the like. Recently, active research has been conducted on the aerosol generating device.

### DISCLOSURE

### Technical Problem

It is an objective of the present disclosure to solve the above and other problems.

It is another objective of the present disclosure to precisely measure the volume of a liquid contained in a cartridge.

It is yet another objective of the present disclosure to provide a stable coupling structure between a sensor for measuring the volume of a liquid and a cartridge.

### Technical Solution

In accordance with an aspect of the present disclosure for accomplishing the above objectives, there is provided an aerosol generating device comprising: a container having a lateral wall that is elongated and shaped to define a storage space that contains a liquid; a plurality of sensors sequentially arranged outside of the lateral wall in a longitudinal direction of the lateral wall, wherein each of the plurality of sensors is configured to detect a volume of the liquid contained in the storage space; a shielding member disposed between adjacent two sensors from among the plurality of sensors; a wick partially positioned inside of the container; and a heater disposed around at least a portion of the wick and being configured to heat the wick.

### Advantageous Effects

According to at least one of the embodiments of the present disclosure, it is possible to precisely measure the volume of a liquid contained in a container.

According to at least one of the embodiments of the present disclosure, a container and a shielding member are coupled to each other, such that reliability of sensors may be improved.

According to at least one of the embodiments of the present disclosure, an aerosol generating device may be manufactured in a compact size.

Further scope of applicability of the present disclosure will become apparent from the detailed description given hereinafter. However, it should be understood that the detailed description and specific examples, while indicating preferred embodiments of the present disclosure, are given by illustration only, since various changes and modifications within the spirit and scope of the present disclosure will become apparent to those skilled in the art from this detailed description.

### DESCRIPTION OF DRAWINGS

FIGS. 1 to 9 are diagrams illustrating examples of an aerosol generating device according to an embodiment of the present disclosure.

### MODE FOR INVENTION

Hereinafter, embodiments of the present disclosure will be described in detail with reference to the accompanying drawings, in which the same or similar elements are designated by the same reference numerals, and a redundant description thereof will be omitted.

The terms “module” and “unit” for elements used in the following description are given simply in view of the ease of the description, and do not have a distinguishing meaning or role.

In addition, it will be noted that a detailed description of known arts will be omitted if it is determined that the detailed description of the known arts can obscure the embodiments of the present disclosure. Further, the accompanying drawings are used to help easily understand various technical features and it should be understood that the embodiments presented herein are not limited by the accompanying drawings, and the present disclosure should be construed to extend to any alterations, equivalents and substitutes in addition to those which are particularly set out in the accompanying drawings.

It will be understood that, although the terms first, second, etc., may be used herein to describe various elements, these elements should not be limited by these terms. These terms are only used to distinguish one element from another.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

As used herein, the singular forms are intended to include the plural forms as well, unless the context clearly indicates otherwise.

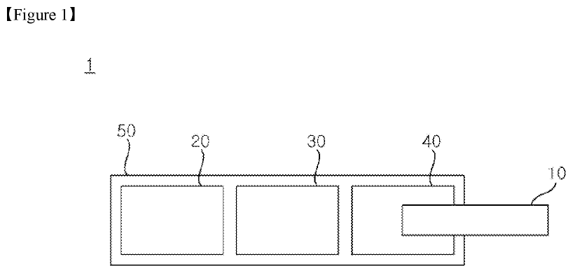

FIG. 1 is a perspective view of an aerosol generating device 1 according to an embodiment of the present disclosure.

Referring to FIG. 1, the aerosol generating device 1 may comprise a casing 50 forming the exterior of the aerosol generating device 1, a controller 30 disposed in the casing 50, a battery 20 disposed in the casing 50, and a cartridge 40 disposed in the casing 50. A stick 10 may be inserted into the aerosol generating device 1.

The casing 50 may form the exterior of the aerosol generating device 1. The casing 50 may be elongated. The casing 50 may surround the battery 20, the controller 30, and the cartridge 40. A hole, through which the stick 10 is inserted, may be formed in an outer surface of the casing 50. A user may hold the aerosol generating device 1 by gripping an outer surface of the casing 50. Electronic components, such as a PCB, an electric wire, etc., may be installed in the casing 50.

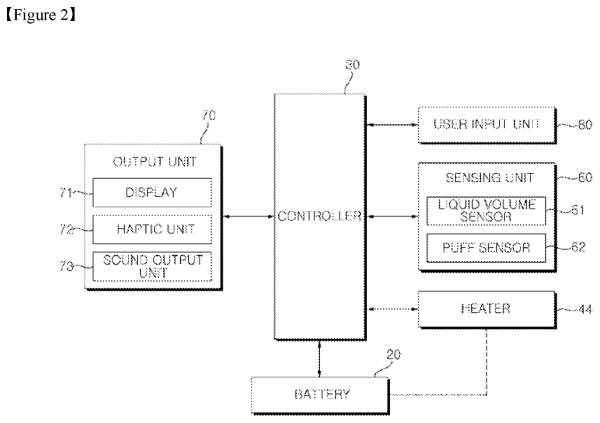

An aerosol generating material may be contained in the cartridge 40. The aerosol generating material may be in a liquid state at room temperature. The aerosol generating material may be referred to as a liquid-type material. The aerosol generating material may be vaporized by a heater 44 (see FIG. 2). The cartridge 40 may be electrically connected to the battery 20.

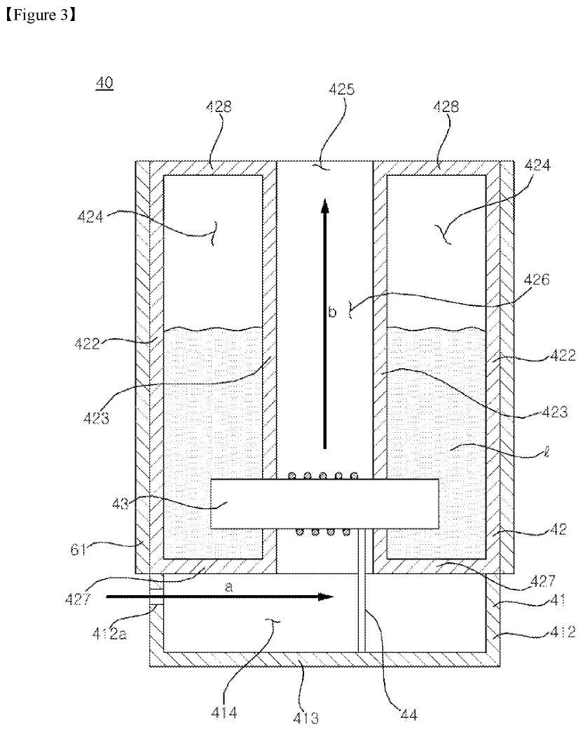

Aerosol may be generated in the cartridge 40. The cartridge 40 may have an elongated shape. The cartridge 40 may extend in a longitudinal direction of the casing 50. An opening 425 (see FIG. 3), through which the stick 10 is inserted, may be formed at one end 428 (see FIG. 3) of the cartridge 40.

The battery 20 may provide power to the aerosol generating device 1. The battery 20 may provide power to the cartridge 40. The battery 20 may provide power to the controller. The battery 20 may be connected to an external power source via a terminal (not shown). The battery 20 may be referred to as a power source. The battery 20 may be a rechargeable battery or a disposable battery. For example, the battery 20 may be a lithium polymer (LiPoly) battery but is not limited thereto.

FIG. 2 is a conceptual diagram illustrating the aerosol generating device 1 according to an embodiment of the present disclosure. The aerosol generating device 1 may comprise the battery 20, the controller 30, the heater 44, a sensing unit 60, an output unit 70, and a user input unit 80.

The controller 30 may be electrically connected to the battery 20. The controller 30 may be electrically connected to the heater 44. The controller 30 may control an amount of power supplied to the heater 44. The controller 30 may shut off power supplied to the heater 44. The controller 30 may turn on or off the heater 44. Although not illustrated in FIG. 2, the aerosol generating device 1 may further comprise a power conversion circuit, e.g., a low dropout (LDO) circuit or a voltage regulator circuit, which converts power from the battery 20 and supplies the converted power to each component of the aerosol generating device 1.

The heater 44 may be disposed in the aerosol generating device 1. The heater 44 may be electrically connected to the battery 20. The heater 44 may generate heat by receiving power from the battery 20. The heater 44 may vaporize the aerosol generating material.

The output unit 70 may output information about a state of the aerosol generating device 1 and may provide the information to a user. For example, the output unit 70 may provide the user with information on whether to replace the heater 44 and whether to charge the battery 100, and information on a remaining amount of the aerosol generating material contained in a container 42.

The output unit 70 may comprise at least one of a display 71, a haptic unit 72, and a sound output unit 73, but is not limited thereto. In the case where the display 71 and a touch pad form a layer structure to be configured as a touch screen, the display 71 may also be used as an input device as well as an output device.

The display 71 may visually provide information about the aerosol generating device 1 to a user. For example, the information about the aerosol generating device 1 may comprise a variety of information, such as a charging/discharging state of the battery 20, a preheated state of the heater 44, an insertion/removal state of an aerosol generating article, or a state in which use of the aerosol generating device 1 is restricted (e.g., a state in which an abnormal article is detected), etc., and the display 71 may output the information to the outside. The display 71 may be, for example, a liquid crystal display (LCD) panel, an organic light-emitting diode (OLED) display panel, and the like. In addition, the display 71 may be a light emitting diode (LED).

The haptic unit 72 may tactually provide information about the aerosol generating device 1 to a user by converting an electrical signal into a mechanical stimulus or an electrical stimulus. For example, the haptic unit 72 may comprise a motor, a piezoelectric element, or an electric stimulator.

The sound output unit 73 may aurally provide information about the aerosol generating device 1 to a user. For example, the sound output unit 73 may convert an electrical signal into a sound signal and may output the signal to the outside.

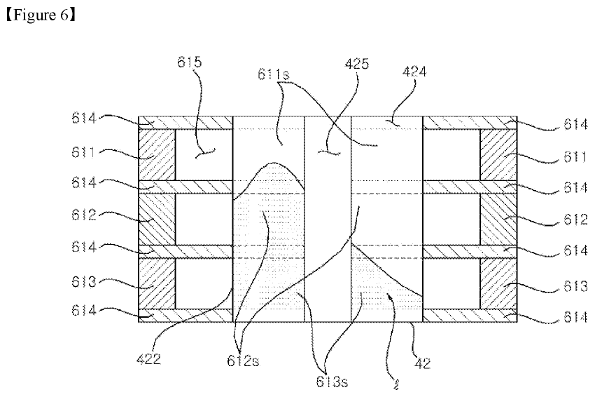

The user input unit 80 may receive information input by a user or may output information to the user. For example, the user input unit 80 may comprise a keypad, a dome switch, a touch pad (capacitive overlay type, resistive overlay type, infrared beam type, surface acoustic wave type, integral strain gauge type, piezoelectric type, etc.), a jog wheel, a jog switch, etc., but is not limited thereto. Although not illustrated in FIG. 6, the aerosol generating device 1 may further comprise a connection interface, such as a universal serial bus (USB) interface, and may be connected to another external device via the connection interface, such as the USB interface and the like, to transmit and receive information or to charge the battery 20.

The sensing unit 60 may comprise a liquid volume sensor 61 and a puff sensor 62. The liquid volume sensor 61 may detect a volume of the aerosol generating material stored in the cartridge 40. The liquid volume sensor 61 will be described in detail below.

The puff sensor 62 may detect a user's puffing action. When the stick 10 is inserted into the aerosol generating device 1 and the aerosol generating device 1 is activated, a user may inhale the generated aerosol through the stick 10. The puff sensor 62 may detect inhalation of the aerosol by the user. For example, the puff sensor 62 may be an atmospheric pressure sensor for detecting a change in ambient atmospheric pressure. When the user inhales the aerosol through the stick 10, air in the aerosol generating device 1 flows such that the puff sensor 62 may detect a change in atmospheric pressure caused by the flow of air.

The controller 30 may control the sensing unit 60. The controller 30 may be electrically connected to the sensing unit 60. The controller 30 may turn on or off the liquid volume sensor 61 and the puff sensor 62. The controller 30 may control operations of the liquid volume sensor 61 and the puff sensor 62. The controller 30 may receive information about the volume of the aerosol generating material which is detected by the liquid volume sensor 61. The controller 30 may receive information about the flow of air which is detected by the puff sensor 61.

FIG. 3 is a cross-sectional view of the cartridge 40 according to an embodiment of the present disclosure. Referring to FIG. 3, the cartridge 40 may comprise a base 41, the container 42, a wick 43, and the heater 44.

The container 42 may contain an aerosol generating material I. The container 42 may be elongated in a longitudinal direction of the cartridge 40. The container 42 may comprise an insertion space 426, an inner wall 423, an outer wall 422, a first end 428, a second end 427, and a storage space 424.

The inner wall 423 and the outer wall 422 may be formed in a cylindrical shape. The first end 428 and the second end 427 of the container 42 may connect the inner wall 423 and the outer wall 422. The first end 428 and the second end 427 of the container 42 may face each other. The inner wall 423 and the outer wall 42 may extend in the longitudinal direction of the cartridge 40. The inner wall 423 may be disposed within the outer wall 422. The outer wall 422 may form an outer circumferential surface of the container 42. The outer wall 422 may be referred to as a lateral wall 422.

The inner wall 423 may be disposed within the outer wall 422. The inner wall 423 may define the insertion space 426 therein. The inner wall 423 and the outer wall 422 may extend in the longitudinal direction of the cartridge 40. The inner wall 423 and the outer wall 422 may be made of a translucent or transparent material. Light may be transmitted through the inner wall 423 and the outer wall 422.

The aerosol generating material I may be contained between the outer wall 422 and the inner wall 423. The inner wall 423, the outer wall 422, the first end 428, and the second end 427 of the container 42 may define the storage space 424 in which the aerosol generating material I is contained. The storage space 424 may have an annular cross-section.

The stick 10 may be inserted into the insertion space 426. The insertion space 426 may communicate with the outside of the cartridge 40 through the opening 425 formed at one end of the container 42. The insertion space 426 may be disposed inside the inner wall 423. The insertion space 426 may have a cylindrical shape. Aerosol vaporized by the heater 44 may flow (b) to the outside of the cartridge 40 through the insertion space 426 and the opening 425.

The insertion space 426 may be disposed inside the cartridge 40. As the insertion space 426 is disposed inside the inner wall 1423, the aerosol generating device 1 may be manufactured in a compact size, compared to the case where the insertion space 426 is provided outside of the container 42.

The base 41 may be provided at one side of the container 42. The base 41 may be provided at one side of the container 42 in the longitudinal direction of the cartridge 40. The base 41 may be disposed at a position adjacent to the wick 43. The base 41 may comprise a bottom 413, a lateral wall 412, and an inner space 414.

The bottom 413 may face the insertion space 426 with respect to the wick 43. The bottom 413 may face the opening 425 of the container 42. The lateral wall 412 may extend from the bottom 413 toward the container 42. The lateral wall 412 may be connected to the container 42. The heater 44 may pass through the bottom 413 to be electrically connected to the battery 20.

The lateral wall 412 may have an inlet 412a. The inlet 412a may pass through the lateral wall 412. The inlet 412a may be open in a direction perpendicular to the lateral wall 412. The inlet 412a may communicate with the outside of the aerosol generating device 1. Air (a) introduced through the inlet 412a may flow to the wick 43.

The inlet 412a may be formed between the container 42 and the bottom 413 of the base 41 in the longitudinal direction of the cartridge 40. The inlet 412a may be disposed closer to the container 42 than to the bottom 413 of the base 41.

The inner space 414 of the base 41 may communicate with a periphery of the wick 61 and the insertion space 426. The periphery of the wick 43 may communicate with the inlet 412a through the inner space 414. The aerosol generating material, which is vaporized by the heater 44, may be liquefied again to be stored in the inner space 414. The aerosol generating material, leaking from the wick 43, may be stored in the inner space 414.

The wick 43 may be connected to the storage space 424 located inside the container 42. The wick 43 may be partially disposed in the container 42. The wick 43 may pass through the inner wall 423 to be connected to the inside of the storage space 424. The wick 43 may be disposed between the insertion space 426 and the inner space 414 of the base 41. The wick 43 may absorb the liquid stored in the storage space 424. The wick 43 may be partially disposed inside the inner wall 423 of the container 42.

The heater 44 may be disposed around the wick 43. The heater 44 may be an elongated wire. The heater 44 may be wound several times around the wick 43. The heater 44 may be in contact with an outer surface of the wick 43. Although not illustrated in FIG. 3, the aerosol generating device 1 may further comprise a power conversion circuit (e.g., DC/DC converter) for converting power from the battery 20 and supplying the converted power to the heater 44. In addition, in the case where the aerosol generating device 1 generates aerosol by induction heating, the aerosol generating device 1 may further comprise a DC/AC converter for converting DC power from the battery 20 into AC power.

In one embodiment of the present disclosure, the heater 44 may be made of any suitable electrical resistance material. For example, the suitable electrical resistance material may comprise, but is not limited to, a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, and the like. Further, the heater 44 may be formed of a metal wire, a metal plate on which an electroconductive track is disposed, a ceramic heating element, etc., but is not limited thereto.

The liquid volume sensor 61 may cover an outer surface of the outer wall 422. The liquid volume sensor 61 may allow a portion of the outer surface of the outer wall 422 to be exposed to the outside of the container 42. The liquid volume sensor 61 may detect the presence of the liquid I, contained in the storage space 424, via the outer wall 422. The liquid volume sensor 61 may detect a volume of the liquid I, contained in the storage space 424, via the outer wall 422.

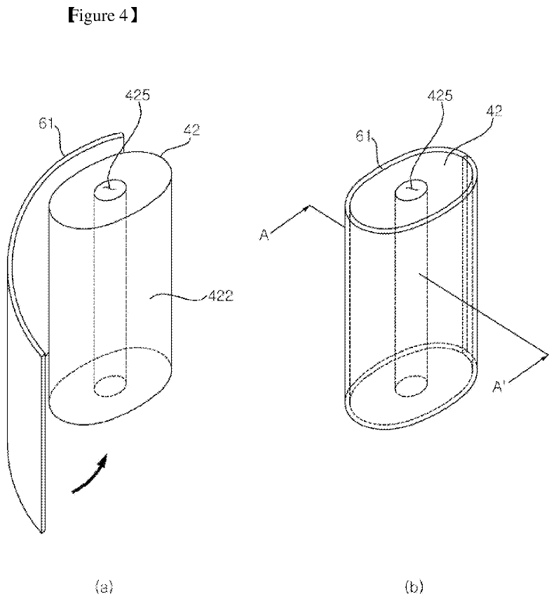

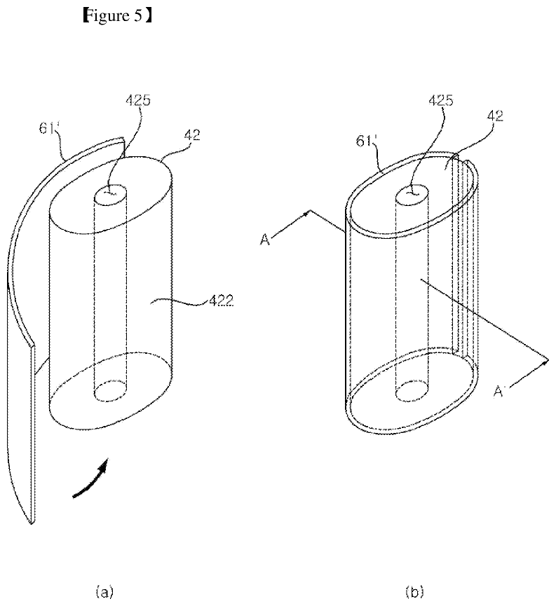

FIGS. 4 and 5 are diagrams illustrating liquid volume sensors 61 and 61′ and the container 42.

Referring to FIG. 4, the liquid volume sensor 61 may cover a lateral wall 422 of the container 42. The liquid volume sensor 61 covers the entire lateral wall 422 of the container 42, such that even when the container 42 is tilted, the liquid volume sensor 61 may accurately measure the volume of the liquid I contained in the storage space 424.

Referring to FIG. 5, the liquid volume sensor 61′ may cover a portion of the lateral wall 422 of the container 42 while allowing a remaining portion thereof to be exposed to the outside of the container 42. Other components disposed in the aerosol generating device 1 may be disposed in the remaining portion that is not covered by the liquid volume sensor 61′, such that the internal space of the aerosol generating device 1 may be used effectively.

FIG. 6 is a diagram illustrating an example in which the aerosol generating device 1 is rocked or tilted such that the liquid I contained in the storage space 424 is shaken. Referring to FIG. 6, a plurality of liquid volume sensors 61 may be provided. A shielding member 614 may be disposed between adjacent liquid volume sensors 611, 612, and 613 among the plurality of liquid volume sensors 61.

For convenience of explanation, a first liquid volume sensor 611 may be referred to as a first sensor 611, a second liquid volume sensor 612 may be referred to as a second sensor 612, and a third liquid volume sensor 613 may be referred to as a third sensor 613.

The liquid volume sensors 611, 612, and 613 may measure the volume of the liquid I, contained in the storage space 424, via the lateral wall 422. For example, the liquid volume sensors 611, 612, and 613 may be capacitance sensors.

A separation space 615 may be formed between the plurality of liquid volume sensors 611, 612, and 613 and the lateral wall 422 of the container 42. However, unlike this embodiment, the plurality of liquid volume sensors 611, 612, and 613 and the lateral wall 422 of the container 42 may be in contact with each other without the separation space 615.

The plurality of liquid volume sensors 611, 612, and 613 may be arranged in a longitudinal direction of the container 42. The plurality of liquid volume sensors 611, 612, and 613 may extend along the lateral wall 422 of the container 42. For example, the liquid volume sensors 611, 612, and 613 may have a ring shape. The plurality of liquid volume sensors 611, 612, and 613 may face an outer surface of the lateral wall 422 of the container 42. The plurality of liquid volume sensors 611, 612, and 613 may cover the outer surface of the lateral wall 422.

The first sensor 611 may surround a first detection space 611s. The second sensor 612 may surround a second detection space 612s. The third sensor 613 may surround a third detection space 613s. The detection spaces 611s, 612s, and 613s may be a portion of the storage space 424 in which the liquid I is contained. The first sensor 611 may measure the volume of the liquid I present in the first detection space 611s. The second sensor 612 may measure the volume of the liquid I present in the second detection space 612s. The third sensor 613 may measure the volume of the liquid I present in the third detection space 613s.

The shielding member 614 may be in contact with the liquid volume sensors 611, 612, and 613. The shielding member 614 may be adhered to the liquid volume sensors 611, 612, and 613. The shielding member 614 may shield noise detected by the respective liquid volume sensors 611, 612, and 613.

For example, the shielding member 614 may prevent the first sensor 611 from detecting the liquid present in the second detection space 612s and/or the third detection space 613s. The shielding member 614 may improve reliability of the liquid volume sensors 611, 612, and 613.

The shielding member 614 may protrude from the liquid volume sensors 611, 612, and 613 toward the lateral wall 422 of the container 42. The shielding member 614 may extend in a width direction of the container 42. The shielding member 614 formed on both sides of the liquid volume sensors 611, 612, and 613 may define the separation space 615. The shielding member 614 formed on both sides of the liquid volume sensors 611, 612, and 613 may narrow the sensing range of the liquid volume sensors 611, 612, and 613, thereby improving the reliability of the liquid volume sensors 611, 612, and 613.

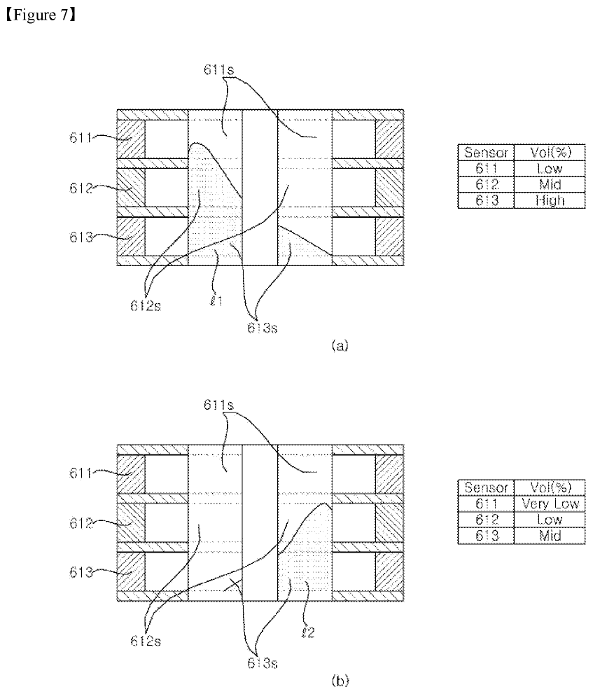

Hereinafter, an example of measuring the volume of the liquid I, contained in the storage space 424, by the liquid volume sensors 611, 612, and 613 will be described with reference to FIG. 7. The liquid volume sensor 611 may measure the volume of a liquid 11, contained in the first detection space 611s, in units of volume percent (vol %).

For example, referring to (a) of FIG. 7, the first sensor 611 may detect that the volume of the liquid present in the first detection space 611s accounts for 7% of a total volume of the first detection space 611s. The second sensor 612 may detect that the volume of the liquid present in the second detection space 612s accounts for 30% of a total volume of the second detection space 612s. The third sensor 613 may detect that the volume of the liquid present in the third detection space 613s accounts for 80% of a total volume of the third detection space 613s.

For example, referring to (b) of FIG. 7, the first sensor 611 may detect that the volume of the liquid present in the first detection space 611s accounts for about 0% of the total volume of the first detection space 611s. The second sensor 612 may detect that the volume of the liquid present in the second detection space 612s accounts for 20% of the total volume of the second detection space 612s. The third sensor 613 may detect that the volume of the liquid present in the third detection space 613s accounts for 55% of the total volume of the third detection space 613s.

Based on the values detected by the first sensor 611, the second sensor 612, and the third sensor 613, the controller 30 may calculate current volumes of liquids 11 and 12 contained in the container 42. For example, referring to (a) of FIG. 7, the controller 30 may calculate the current volume of the liquid 11, contained in the container 42, to be about 40%. For example, referring to (b) of FIG. 7, the controller 30 may calculate the current volume of the liquid 12, contained in the container 42, to be about 25%.

As illustrated in FIG. 7, the first sensor 611, the second sensor 612, and the third sensor 613 may detect Low, Mid, and High values as the volumes of the liquids present in the respective detection spaces 611s, 612s, and 613s. Based on the Low, Mid, and High values, the controller 30 may calculate the volume of the liquid contained in the container 42.

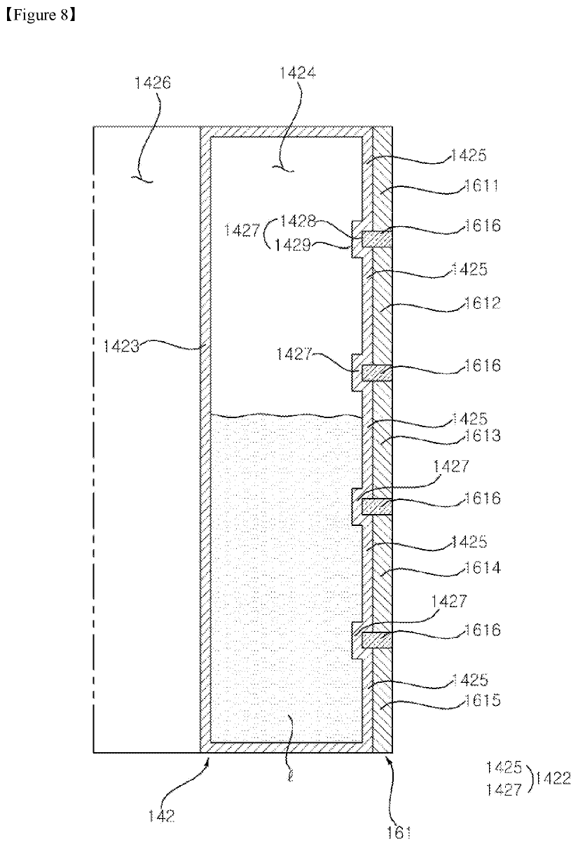

FIG. 8 is a diagram illustrating a container 142 and a liquid volume sensor 161. Referring to FIG. 8, the container 142 may comprise a plurality of first layers 1425, a plurality of second layers 1427, grooves 1428, and protrusions 1429.

A lateral wall 1422 of the container 142 may comprise the plurality of first layers 1425 and the plurality of second layers 1427. The plurality of first layers 1425 and the plurality of second layers 1427 may face the liquid volume sensor 161. The plurality of first layers 1425 and the plurality of second layers 1427 may be made of a translucent or transparent material. The liquid volume sensor 161 may measure a volume of the liquid I, contained in a storage space 1424, via the plurality of first layers 1425.

The first layer 1425 and the second layer 1427 may extend in a circumferential direction of the container 1424. The first layer 1425 and the second layer 1427 may be sequentially arranged in a longitudinal direction of the container 142. The first layer 1425 and the second layer 1427 may be disposed alternately in the longitudinal direction of the container 142. The second layer 1427 may be disposed between adjacent first layers 1425.

The second layer 1427 may comprise the groove 1428 and the protrusion 1429. The groove 1428 may be formed in an outer surface of the second layer 1427. The protrusion 1429 may be formed on an inner surface of the second layer 1427. The groove 1428 and the protrusion 1429 may overlap each other in a width direction of the container 142. The protrusion 1429 may be disposed at a position corresponding to the groove 1428. The protrusion 1429 may be integrally formed with the container 142. There may be a plurality of protrusions 1429 and grooves 1428.

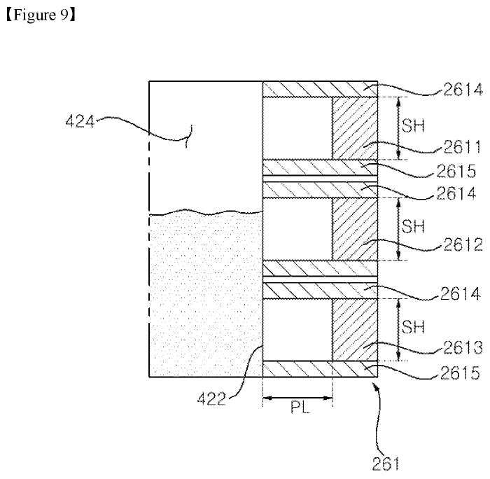

FIG. 9 is a diagram illustrating the container 42 and a liquid volume sensor 261 according to an embodiment of the present disclosure. Referring to FIG. 9, a plurality of liquid volume sensors 261 may be spaced apart from each other in the longitudinal direction of the container 42.

Shielding members 2614 may be disposed on both sides of the plurality of liquid volume sensors 261. The shielding members 2614 may narrow the sensing range of the plurality of liquid volume sensors 261. The shielding members 2614 may be disposed on both sides of the respective liquid volume sensors 2611, 2612, and 2613. The plurality of shielding members 2614 may comprise a first shielding member, disposed between adjacent liquid volume sensors 2611, 2612, and 2613, and a second shielding member disposed between the first shielding member and the liquid volume sensors 2611, 2612, and 2613.

Meanwhile, the shielding member 2614 may extend toward the storage space 424 of the container 42 and may protrude from the liquid volume sensors 2611, 2612, and 2613. A length of the shielding member 2614 that protrudes from the liquid volume sensors 2611, 2612, and 2613 toward the storage space 424 may be defined as a protruding length PL. Further, a length of the liquid volume sensors 2611, 2612, and 2613 in the longitudinal direction of the container 42 may be defined as a sensing length SH. A relational expression of PL≥SH/2 may be satisfied between the protruding length PL and the sensing length SH. The relational expression may also be applied to the embodiments illustrated in FIGS. 6 and 8.

Referring to FIGS. 1 to 9, an aerosol generating device 1 according to an embodiment of the present disclosure comprises: a container 42 elongated with a first end 428 and a second end 427 and having a lateral wall 422 disposed between the first end 428 and the second end 427, the lateral wall 422 defining a storage space 424 in which a liquid is contained; a plurality of sensors 611, 612, and 613 disposed on an outside of the lateral wall 422, sequentially arranged in a longitudinal direction of the lateral wall 422, and configured to detect a volume of the liquid contained in the container; a shielding member 614 disposed between adjacent sensors 611, 612, and 613 among the plurality of sensors 611, 612, and 613; a wick 43 partially connected to an inside of the container 42; and a heater 44 disposed around the wick 43 and configured to heat the wick 43.

According to another embodiment of the present disclosure, the plurality of sensors 611, 612, and 613 and the shielding member 614 may cover an outer surface of the lateral wall 422 of the container 42.

According to another embodiment of the present disclosure, a lateral wall 1422 of a container 142 may comprise: a plurality of first portions 1425, wherein each of the plurality of first portions 1425 face a corresponding sensor of the plurality of sensors 1611, 1612, 1613, 1614, and 1615; and a second portions 1427 individually located between adjacent ones of the plurality of first portions 1425 and facing the shielding member 1616.

According to another embodiment of the present disclosure, the second layer 1427 may comprise a groove 1401 which is recessed from an outer surface of the lateral wall 1422 of the container 142 into an inner surface thereof, and into which the shielding member 1616 is inserted.

According to another embodiment of the present disclosure, the shielding member 1616 may be disposed between the plurality of sensors 1611, 1612, 1613, 1614, and 1615, and may have a portion which protrudes to be inserted into the groove 1401.

According to another embodiment of the present disclosure, the second layer 1427 may further comprise a protrusion 1429 protruding from the inner surface of the lateral wall 1422 of the container 142 toward the storage space 1424.

According to another embodiment of the present disclosure, the protrusion 1429 may be disposed at a position corresponding to the groove 1428.

According to another embodiment of the present disclosure, the sensors 611, 612, and 613 may allow at least a portion of the outer surface of the lateral wall 422 to be exposed outside of the container 42.

According to another embodiment of the present disclosure, a shielding member 2614 and 2615 may comprise: a first shielding member 2614 disposed between adjacent sensors 2611, 2612, and 2613; and a second shielding member 2615 disposed between the first shielding member 2614 and any one 2611 and 2612 of the adjacent sensors 2611, 2612, and 2613.

According to another embodiment of the present disclosure, when a length of the shielding member 2614 and 2615 that protrudes from the sensors 2611, 2612, and 2613 in a width direction of the lateral wall 422 is defined as a protruding length PL, and a length of the sensors 2611, 2612, and 2613 in the longitudinal direction of the lateral wall 422 is defined as a sensing length SH, a relational expression of (PL)≥(SH)/2 may be satisfied.

According to another embodiment of the present disclosure, the container 42 may comprise an inner wall 423 extending inside the lateral wall 422 in the longitudinal direction of the lateral wall 422, defining the storage space 424 formed between the inner wall 423 and the lateral wall 422, and having an insertion space 426 formed therein.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An aerosol generating device comprising:
a container having a lateral wall that is elongated and shaped to define a storage space that contains a liquid;
a plurality of sensors sequentially arranged outside of the lateral wall in a longitudinal direction of the lateral wall, wherein each of the plurality of sensors is configured to detect a volume of the liquid contained in the storage space;
a shielding member disposed between adjacent two sensors from among the plurality of sensors;
a wick partially positioned inside of the container; and
a heater disposed around at least a portion of the wick and being configured to heat the wick.

2. The aerosol generating device of claim 1, wherein the plurality of sensors and the shielding member cover an outer surface of the lateral wall of the container.

3. The aerosol generating device of claim 2, wherein the lateral wall of the container comprises:
a plurality of first portions respectively corresponding to one of the plurality of sensors, wherein each of the plurality of first portions face a corresponding sensor of the plurality of sensors; and
a plurality of second portions individually located between adjacent ones of the plurality of first portions and facing the shielding member.

4. The aerosol generating device of claim 3, wherein each of the plurality of second portions is shaped to define a groove relative to an outer surface of the lateral wall, wherein respective portions of the shielding member are received by the groove of a respective one of the plurality of second portions.

5. The aerosol generating device of claim 4, wherein the shielding member comprises a plurality of protrusions that are separately received by the groove of a respective one of the plurality of second portions.

6. The aerosol generating device of claim 4, wherein the plurality of second portions each comprises a protrusion that extends from an inner surface of the lateral wall and toward the storage space.

7. The aerosol generating device of claim 6, wherein the protrusions of the plurality of second portions are located to separately correspond with the groove of a respective one of the plurality of second portions.

8. The aerosol generating device of claim 2, wherein the plurality of sensors are sized to allow at least a portion of the outer surface of the lateral wall to be exposed outside of the container.

9. The aerosol generating device of claim 1, wherein the shielding member comprises:
a first shielding member disposed between adjacent two sensors from among the plurality of sensors; and
a second shielding member disposed between the first shielding member and any one of the adjacent two sensors.

10. The aerosol generating device of claim 1, wherein
a length of the shielding member that protrudes beyond an end of the plurality of sensors in a width direction of the lateral wall is defined as a protruding length PL,
and a length of each of the plurality of sensors in the longitudinal direction of the lateral wall is defined as a sensing length SH, and
a relational expression of (PL)≥(SH)/2 is satisfied.

11. The aerosol generating device of claim 1, wherein the container comprises an inner wall that is located inside the lateral wall and extends in the longitudinal direction of the lateral wall, wherein the inner wall is shaped to define an elongated insertion space,
wherein the storage space is formed between the inner wall and the lateral wall.

12. An aerosol generating device comprising:
a container having a lateral wall that is elongated and shaped to define a storage space that contains a liquid;
a plurality of sensors sequentially arranged outside of the lateral wall in a longitudinal direction of the lateral wall, wherein each of the plurality of sensors is positioned adjacent to the lateral wall and is configured to detect a presence of the liquid contained in the storage space;
a shielding member disposed between adjacent two sensors from among the plurality of sensors;
a wick partially positioned inside of the container; and
a heater disposed around at least a portion of the wick and being configured to heat the wick.

13. The aerosol generating device of claim 12, further comprising:
a controller configured to:
receive an input from the plurality of sensors based on respective detection of the presence of the liquid contained in the storage space; and
calculate a volume of the liquid contained in the storage based on the received input.
